(19) United States
(12) Patent Application Publication
(10) Pub. No.: US 2014/0359989 A1
(43) Pub. Date: Dec. 11, 2014

(54) METHOD OF REMANUFACTURING A SEALING SURFACE

(71) Applicant: Caterpillar Inc., Peoria, IL (US)

(72) Inventors: Kegan Luick, Corinth, MS (US); Timothy S. Graham, Golden, MS (US); Jeffrey M. Stark, Corinth, MS (US)

(21) Appl. No.: 13/913,702

(22) Filed: Jun. 10, 2013

(51) Int. Cl. B23P 23/04; B23P 6/00; B23K 26/34

(52) U.S. Cl. CPC B23P 23/04; B23K 26/34; B23P 6/00
USPC 29/402.02

(57) ABSTRACT

A method of remanufacturing a seal surface includes forming a groove into a component surface at a location of a worn seal surface. A bead of new seal material may then be deposited in the groove by laser cladding. The bead of new seal material may then be machined to form a new seal surface that is generally flush with the component surface.

### TECHNICAL FIELD

The present disclosure relates generally to a method of remanufacturing worn seal surfaces. More particularly, the present disclosure relates to a method of remanufacturing a worn seal surface including using a laser cladding process.

### BACKGROUND

Sealing surfaces of metal components, such as, for example, housings, water pump shafts, oil cooler shells and other loaded seal joints, often suffer from wear at the seal location. Seals at these locations may be static such as, for example, an O-ring or gasket, or dynamic such as, for example, a lip-seal or sealing bearing. Seal surface wear may include corrosion, erosion and cavitations, or any combination thereof. In any case, wearing of the seal surface may compromise the seal integrity and may therefore compromise the reliability of the component of which the sealing surface is a part. Failure of a seal joint may require repair or replacement of the component before or at rebuild of the component.

Conventional repair methods for worn seal joints include applying a thermal spray over the surface of the metal component that includes the worn seal surface. This method of repairing seal surfaces using thermal spraying suffers from a number of disadvantages. For instance, thermal spraying relies upon a mechanical bond of the sprayed material to the component surface, and the mechanical bond is not suited for all locations and surfaces. Furthermore, thermal spraying requires extension material preparation, which can make the process time consuming and costly. Another repair method is to use metal brazes or solders to repair worn seal surfaces, but these materials and the processes for utilizing them may cause distortion to the component.

U.S. Patent Publication No. 2012/0036715, published Feb. 16, 2012, discloses a method of repairing a cylinder head having corrosion and erosion of the sealing surface around the cooling inlet. The corroded material is machined to a selected depth and width creating a pocket having a bottom wall surface and an annular side wall surface surrounding the coolant inlet port. An annular insert is provided, the insert having a thickness greater than the depth of the machined pocket. An adhesive is applied to maintain the insert in the pocket, and the top wall of the insert is machined to a dimension flush with the sealing surface of the head for receipt of a replacement gasket. However, use of an adhesive complicates the process and renders the repair method less than ideal. Polymer adhesives can degrade at high temperatures and may need to be replaced during a subsequent overhaul.

The method of remanufacturing a seal surface of the present disclosure alleviates one or more deficiencies of the prior art or otherwise improves the art.

### SUMMARY OF THE INVENTION

One aspect of the present disclosure is directed to [TO BE COMPLETED WHEN CLAIMS ARE FINALIZED].

Another aspect of the present disclosure is directed to [TO BE COMPLETED WHEN CLAIMS ARE FINALIZED].

Another aspect of the present disclosure is directed to [TO BE COMPLETED WHEN CLAIMS ARE FINALIZED].

### BRIEF DESCRIPTION OF THE DRAWINGS

FIG. 1 is a cross-sectional representation of a worn seal surface of a component surface;

FIG. 2 is a cross-sectional representation of the step of forming a groove in a component surface;

FIG. 3 is a cross-sectional representation of a groove formed in a component surface;

FIG. 4 is a cross-sectional representation of a bead of new seal material deposited into the groove; and

FIG. 5 is a cross-sectional representation of a new seal surface in the component surface.

### DETAILED DESCRIPTION

Referring now to FIG. 1, a component part with a worn seal surface is shown and is indicated generally by the numeral 10. It should be appreciated that the FIGS. 1-5 are included for illustration purposes only, and the components shown may not be drawn to scale. The component part 10 may be any metal component that includes a worn seal surface 12 in an interfacing surface 11, including, for example, housings, water pump shafts and oil cooler shells. The worn seal surface 12 of the component part 10 may be caused by erosion (wear caused by impact), corrosion (wear caused by chemical reactions) and/or cavitation (wear caused by fluids). In any case, the worn seal surface 12 may be worn to an extent that repair of the seal surface is necessary in order to maintain the integrity of the sealed joint created by the interaction between the sealing surface and a gasket or other sealing member. The component part 10 may be formed from any known material, including, for example, iron, aluminum, steel, titanium, and copper.

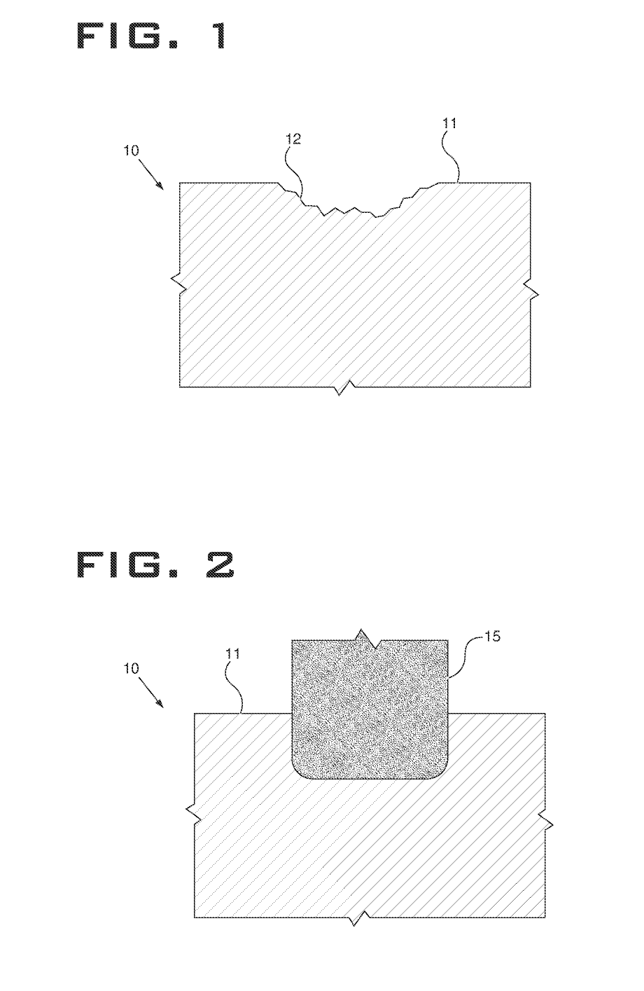

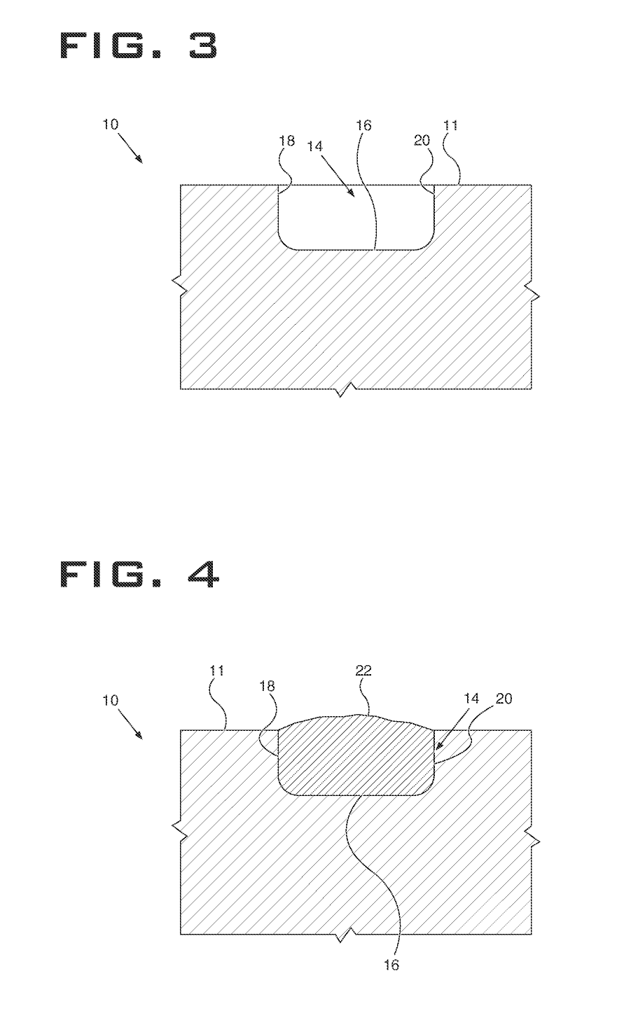

Once a component part 10 has been inspected and a worn seal surface 12 in an interfacing surface 11 has been identified, the process of repairing the worn seal surface may commence. Referring to FIGS. 2 and 3, a groove 14 may first be created in the component part 10 at the location of the worn seal surface 12, thereby removing the worn and damaged portion of the component part. The groove 14 may be formed using any suitable tool 15 capable of separating the material of the worn seal surface 12 and some surrounding material from the component part 10. In an exemplary embodiment, a milling cutter, such as, for example, a ball nose cutter of a milling machine, may be used to form the groove 14 in a surface of the component part 10 that is generally flat. Rotation of the milling cutter acts to remove material from the component part 10 at and surrounding the worn seal surface 12. Where the seal surface 12 is formed on a round surface such as, for example, a shaft, a lathe may be used to form groove 14.

The groove 14 formed by the milling cutter 15 may have a bottom surface 16 extending between two side surfaces 18 and 20 in a section view, as best shown in FIG. 3. In a particular embodiment the bottom surface 16 may be generally flat as it extends between side surfaces 18 and 20. The groove 14 may form a section profile having at least one curved portion, and in some embodiments a pair of curved portions at the transition from side surfaces 18 and 20 to bottom surface 16. It is also contemplated that bottom surface 16 of groove 14 may be concave with an arcuate bottom surface 16 (not shown) extending between side surface 18 and 20. The side surfaces 18 and 20 may be substantially parallel to one another.

In a particular embodiment, groove 14 may have a maximum depth D of between approximately 0.1 and 8 mm and a width W between side surfaces 18 and 20 of between approximately 2 and 30 mm. The ratio of the width W of the groove 14 to the depth D of the groove 14 may be at least 4.0:1.

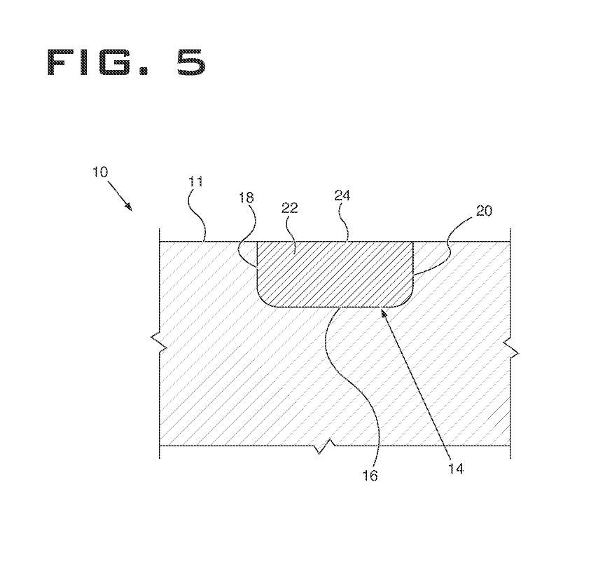

Following the formation of groove 14, a bead of new seal material 22 may be deposited within groove 14 by laser cladding, as shown in FIG. 4. The step of depositing the new seal material 22 into the groove 14 by laser cladding may include melting a powdered or wire feedstock of the new seal material into the groove by use of a laser. The component part 10 may be moved relative to the laser and feedstock in order to fill groove 14. Alternatively, the laser and feedstock may be mounted to an automated apparatus that moves relative to the component part 10 in order to fill groove 14. The laser cladding process creates a metallurgical bond between the new seal material 22 and the component part 10, alleviating the need for other bonding agents to secure the new seal material 22 within the groove 14.

While it is contemplated that in many applications a single bead of new seal material 22 may be sufficient to fill groove 14, it is also contemplated that a plurality of beads of new seal material 22 may be deposited in the groove 14. For example, where a dynamic seal is formed by the interfacing surface 11 of the component part 10, a wider groove 14 and multiple beads of new seal material 22 may be required to repair the worn seal surface 12. Even If a plurality of beads of new seal material 22 are deposited in the groove 14, the remaining steps of the process for repairing the worn seal surface 12 remain the same as if a single bead of new seal material 22 were provided. Where multiple beads of new seal material are necessary to fill groove 14, they may be deposited in groove 14 simultaneously, or, alternatively, one bead of new seal material 22 may be applied after another until groove 14 is completely filled with new seal material.

New seal material 22 may be any material suitable for forming a sealing surface in component part 10, and may have good corrosion and/or wear resistant properties. For example, new seal material 22 may be stainless steel or other steel alloys, austenitic nickel-chromium-based steel alloys, titanium or aluminum. As used herein, stainless steel refers to a steel alloy having a chromium content of greater than or equal to 10.5%. In an exemplary embodiment, the new seal material 22 may be different than the material used to form component part 10. The new seal material 22 may possess greater corrosion and wear resistant properties than the material used to form component part 10. For example, new seal material 22 may have a hardness that is greater than the hardness of the material of component part 10. In other embodiments the new seal material 22 may be substantially identical to the material used to form the component part 10.

Following the step of depositing one or more beads of new seal material 22 in groove 14, excess material may be removed by known machining techniques to return the component part 10 to the original specifications. The step of machining excess material from the one or more beads of new seal material 22 results in the creation of a new seal surface 24 that is substantially flush with the surface of the component part 10, as shown in FIG. 5. New seal material 22 may substantially fill groove 14, and the new seal surface 24 may provide improved wear resistance as compared to the material of component part 10.

Although the above-described process is intended to repair worn seal surfaces, it is also contemplated that steps of the disclosed process may be used during original manufacturing of the component. In this way the component 10 may be provided with a sealing surface 24 with improved wear resistance as compared to a sealing surface formed from the material of the component itself (e.g. cast iron). The groove 14 may be formed into the interfacing surface 11, or component 10 may be manufactured (e.g. cast) to include the groove 14 at a desired sealing location. The groove 14 may then be filled with a new seal material 22 by laser cladding and the new seal material 22 machined to form the new seal surface 24. In the case of an original component, the new seal material 22 is different from the material of the rest of component 10, with the new seal material providing greater corrosion and/or wear resistance than the material of the rest of component 10.

### INDUSTRIAL APPLICABILITY

The method of the present disclosure may be useful in repairing sealing surfaces of any component part having a worn sealing surface. The worn material may be removed, a new seal material 22 deposited by laser cladding and machined to original specifications to extend the life of the component part 10 and maintain the reliability of the seal joint formed by the new seal surface 24. The repair method of the present disclosure may be more precise and less time consuming than many conventional seal surface repair techniques. Furthermore, the method of the present disclosure may also be applicable in locations and for operating conditions where some other known repair methods are not suitable. Alternatively, the method of the present disclosure may be adapted to provide an original component with an improved seal surface.

The new seal surface 24 produced by the disclosed method may have superior corrosion and wear resistant properties as compared to the material used to form the component part 10. Thus, the reliability of the seal joint formed with the new seal surface 24 may be improved as compared to the reliability of the seal joint formed from the original seal surface of component part 10. Repair of the worn seal surface 12 using the disclosed method also focuses only on the worn region of the component part, rather than an entire surface of the component part 10 containing the sealing surface as with some prior art methods. The dimensional relationship R between the depth and width of the groove 14 formed in component part 10 may impact the quality of the new seal surface 24.

It will be apparent to those skilled in the art that various modifications and variations can be made to the repair method of the present disclosure without departing from the scope of the disclosure. Other embodiments will be apparent to those skilled in the art from consideration of the specification. It is intended that the specification and examples be considered as exemplary only, with a true scope of the disclosure being indicated by the following claims and their equivalent.

What is claimed is:

1. A method of remanufacturing a seal surface comprising:
forming a groove in an interfacing surface of a component at a location of a worn seal surface;
depositing seal material within the groove by laser cladding; and
machining the seal material to form a remanufactured seal surface that is generally flush with the interfacing surface.

2. The method of claim 1, further comprising inspecting the component prior to forming a groove for determining whether forming a remanufactured seal surface is necessary.

3. The method of claim 1, further comprising heat treating the remanufactured seal surface to adjust the properties of the seal material.

4. The method of claim 1, wherein the groove formed during said forming step has a section profile with a curved portion.

5. The method of claim 4, wherein the groove is formed using a milling cutter during said forming step.

6. The method of claim 1, wherein the groove formed during said forming step has a generally planar inner surface spanning between opposing side surfaces.

7. The method of claim 1, wherein the seal material is a first material and the interfacing surface of the component is formed of a second material that is different from the first material.

8. The method of claim 1, wherein the seal material is a first material and the interfacing surface of the component is formed of a second material that is substantially the same as the first material.

9. The method of claim 1, wherein the seal material is a stainless steel material having a chromium content of greater than or equal to 10.5%.

10. The method of claim 1, wherein the seal material is an austenitic nickel-chromium-based alloy.

11. A method of remanufacturing a seal surface comprising:
forming a groove in an interfacing surface of a component made of a first material, the groove having a ratio of width W to depth D of at least 4.0:1;
depositing a second material in the groove by laser cladding, the second material being different than the first material and being metallurgically bonded to the first material; and
machining the second material to form a remanufactured seal surface that is substantially flush with the interfacing surface of the component.

12. The method of claim 11, further comprising inspecting the interfacing surface of the component prior to forming a groove to determine whether forming a remanufactured seal surface is necessary.

13. The method of claim 11, further comprising heat treating the remanufactured seal surface to adjust the properties of the second material.

14. The method of claim 11, wherein the groove formed during said forming step has a section profile with a curved portion.

15. The method of claim 14, wherein the groove is formed using a milling cutter during said forming step.

16. The method of claim 11, wherein the groove is formed using a lathe during said forming step.

18. The method of claim 11, wherein the second material is a stainless steel material having a chromium content of greater than or equal to 10.5%.

19. The method of claim 11, wherein the second material is an austenitic nickel-chromium-based alloy.

20. A method of remanufacturing a seal surface comprising:
forming a groove in an interfacing surface of a component at a location of a worn seal surface;
depositing a plurality of beads of seal material within the groove by laser cladding; and
machining the plurality of beads of seal material to form a remanufactured seal surface that is generally flush with the interfacing surface of the component, the seal material being metallurgically bonded to the component.
